(19) United States
(12) Patent Application Publication
(10) Pub. No.: US 2019/0280536 A1
(43) Pub. Date: Sep. 12, 2019

(54) ROTARY ELECTRIC MACHINE COOLING STRUCTURE

(71) Applicant: HONDA MOTOR CO., LTD., Tokyo (JP)

(72) Inventor: Masahiro Niijima, Wako-shi (JP)

(21) Appl. No.: 16/290,984

(22) Filed: Mar. 4, 2019

(30) Foreign Application Priority Data
Mar. 9, 2018 (JP) 2018-043615

(51) Int. Cl. H02K 1/20; H02K 21/14

(52) U.S. Cl. CPC H02K 1/20; H02K 21/14

(57) ABSTRACT

A rotary electric machine cooling structure includes a coolant passage that is provided on an outer circumferential part of a stator and that has a cylindrical shape substantially along an outer circumferential surface of the stator. The cooling structure includes a coolant inflow port, a coolant outflow port, and a plurality of heat release fins. The coolant inflow port is provided on one end side in an axial direction of the coolant passage. The coolant outflow port is provided on another end side in the axial direction of the coolant passage. The heat release fin protrudes outward in a radial direction from an inner circumferential surface in a radial direction inside the coolant passage. The heat release fin is arranged in a middle region in the axial direction of the coolant passage that is separated from the inflow port and the outflow port.

### CROSS-REFERENCE TO RELATED APPLICATION

Priority is claimed on Japanese Patent Application No. 2018-043615, filed on Mar. 9, 2018, the contents of which are incorporated herein by reference.

### BACKGROUND

### Field of the Invention

The present invention relates to a rotary electric machine cooling structure that performs cooling by a coolant.

### Background

As a rotary electric machine that is mounted on a vehicle and the like, such a machine is known which includes a rotor that is rotated integrally with a rotation shaft and a stator that is arranged on an outer side in a radial direction of the rotor, wherein a plurality of permanent magnets are arranged on an outer circumference of the rotor, and a coil is wound around the stator. In this type of rotary electric machine, during the operation, the coil part of the stator easily generates heat.

As a countermeasure against this, a rotary electric machine is known in which a cooling structure that includes a coolant passage having a cylindrical shape is arranged on an outer circumferential part of a stator and which cools the heat by a coil by allowing a coolant to flow through the coolant passage of the cooling structure (for example, refer to Japanese Patent Application, Publication No. 2005-110451A).

### SUMMARY

In the rotary electric machine as described above, as a method of enhancing a cooling efficiency with respect to the stator, it is conceivable that a plurality of heat release fins that protrude outward in the radial direction are provided on an inner circumferential surface (circumferential surface on a side close to the stator) in the radial direction inside the coolant passage. In this case, it is possible to efficiently release heat of the stator by the heat release fin to the coolant in the coolant passage.

However, when heat release fins having the same shape and the same size are arranged uniformly inside the coolant passage, it becomes difficult to sufficiently cool a middle region in the axial direction of the stator that requires cooling, and it becomes necessary to increase an output of a pump apparatus for supplying the coolant.

An aspect of the present invention provides a rotary electric machine cooling structure that is capable of efficiently cooling a middle region in an axial direction of a stator by a coolant.

A rotary electric machine cooling structure according to an aspect of the present invention includes a coolant passage that is provided on an outer circumferential part of a stator and that has a cylindrical shape substantially along an outer circumferential surface of the stator, the rotary electric machine cooling structure including: a coolant inflow port that is provided on one end side in an axial direction of the coolant passage; a coolant outflow port that is provided on another end side in the axial direction of the coolant passage; and a plurality of heat release fins that protrude outward in a radial direction from an inner circumferential surface in a radial direction inside the coolant passage, wherein the heat release fin is arranged in a middle region in the axial direction of the coolant passage that is separated from the inflow port and the outflow port.

According to the configuration described above, when the coolant is introduced from the inflow port on one end side in the axial direction of the coolant passage, the coolant proceeds to the middle region in the axial direction of the coolant passage, passes through a gap between the plurality of heat release fins and an inner wall of the coolant passage, and flows to the outside from the outflow port on another end side in the axial direction of the coolant passage. The heat release fin is not provided to protrude in regions close to the inflow port and the outflow port inside the coolant passage, and therefore, a flow path resistance becomes small in the regions. Therefore, the coolant easily flows in the inside of the coolant passage and easily flows out from the coolant passage. Further, the plurality of fins are provided to protrude in the middle region in the axial direction of the coolant passage, and therefore, when the coolant passes through the gap between the plurality of heat release fins and the inner wall of the coolant passage, the flow rate of the coolant is increased. Therefore, in the middle region in the axial direction of the stator, a heat exchange is efficiently performed between the stator and the coolant via the plurality of heat release fins.

The plurality of heat release fins may be formed such that one of the plurality of heat release fins that is arranged at a further middle position in the axial direction of the coolant passage has a higher protrusion height.

In this case, the flow rate of the coolant that flows inside the coolant passage becomes faster at a further middle position in the axial direction of the coolant passage, and the flow path resistance becomes small at a further outer position in the axial direction. Therefore, when this configuration is employed, the middle part in the axial direction of the stator at which heat is easily accumulated is able to be efficiently cooled by the coolant.

One heat release fin among the plurality of heat release fins that is arranged at a further middle position in the axial direction of the coolant passage may have a narrower pitch between the one heat release fin and an adjacent heat release fin among the plurality of heat release fins.

In this case, the flow rate of the coolant that flows inside the coolant passage becomes faster at a further middle position in the axial direction of the coolant passage, and the flow path resistance becomes small at a further outer position in the axial direction. Therefore, when this configuration is employed, the middle part in the axial direction of the stator at which heat is easily accumulated is able to be efficiently cooled by the coolant.

One of the plurality of heat release fins that is arranged at a further outer position in the axial direction of the coolant passage may be set such that a cutout area in a circumferential direction is larger.

In this case, the flow rate of the coolant that flows inside the coolant passage becomes faster at a further middle position in the axial direction of the coolant passage, and the flow path resistance becomes small at a further outer position in the axial direction. Therefore, when this configuration is employed, the middle part in the axial direction of the stator at which heat is easily accumulated is able to be efficiently cooled by the coolant.

A rotary electric machine cooling structure according to another aspect of the present invention includes a coolant passage that is provided on an outer circumferential part of a stator and that has a cylindrical shape substantially along an outer circumferential surface of the stator, the rotary electric machine cooling structure including: a coolant inflow port that is provided in a middle region in an axial direction of the coolant passage; a coolant outflow port that is provided in a middle region in the axial direction of the coolant passage and at a position which is separated in a circumferential direction from the inflow port; and a plurality of heat release fins that protrude outward in a radial direction from an inner circumferential surface in a radial direction inside the coolant passage, wherein the heat release fin is arranged in an outer region in the axial direction of the coolant passage that is separated from the inflow port and the outflow port.

According to the configuration described above, when the coolant is introduced from the inflow port in the middle region in the axial direction of the coolant passage, part of the coolant flows along the circumferential direction in the middle region in the axial direction and flows to the outside from the outflow port. Since the heat release fin is not provided to protrude in the middle region in the axial direction of the coolant passage, a flow path resistance in the vicinity of the inflow port and in the vicinity of the outflow port becomes small, and the coolant smoothly flows from the inflow port toward the outflow port. At this time, it becomes difficult for the coolant to flow in the outer region in the axial direction of the coolant passage compared to the middle region in the axial direction. However, the plurality of heat release fins are provided to protrude in the outer region in the axial direction, and therefore, a heat exchange between the coolant and the outer region in the axial direction of the stator is able to be efficiently performed by the plurality of heat release fins.

The plurality of heat release fins may be formed such that one of the plurality of heat release fins that is arranged at a further outer position in the axial direction of the coolant passage has a higher protrusion height.

In this case, the heat release fin that is arranged at a further outer position in the axial direction has a larger contact area with the coolant, and as a result, a heat exchange efficiency with the coolant by the heat release fin is enhanced.

One heat release fin among the plurality of heat release fins that is arranged at a further outer position in the axial direction of the coolant passage may have a narrower pitch between the one heat release fin and an adjacent heat release fin among the plurality of heat release fins.

In this case, the density of the heat release fins per an axial direction distance is higher at a further outer region in the axial direction of the coolant passage, and a heat exchange efficiency with the coolant by the heat release fin is enhanced.

The rotary electric machine cooling structure according to an aspect of the present invention includes: the inflow port that is provided on one end side in the axial direction of the coolant passage; the outflow port that is provided on another end side in the axial direction of the coolant passage; and the plurality of heat release fins that protrude outward in the radial direction from the inner circumferential surface in the radial direction inside the coolant passage, wherein the plurality of heat release fins are arranged in the middle region in the axial direction of the coolant passage. Therefore, according to the rotary electric machine cooling structure according to the aspect of the present invention, the flow of the coolant is smoothened in the vicinity of the inflow port and the outflow port inside the coolant passage, the flow rate of the coolant is increased in the middle region in the axial direction inside the coolant passage, and it is possible to efficiently cool the middle region in the axial direction of the stator by the coolant.

A rotary electric machine cooling structure according to another aspect of the present invention includes: the inflow port that is provided in the middle region in the axial direction of the coolant passage; the outflow port that is provided in the middle region in the axial direction of the coolant passage and at a position which is separated from the inflow port in the circumferential direction; and the plurality of heat release fins that protrude outward in the radial direction from the inner circumferential surface in the radial direction inside the coolant passage, wherein the plurality of heat release fins are arranged in the outer region in the axial direction of the coolant passage. Therefore, the flow of the coolant from the inflow port to the outflow port in the middle region in the axial direction of the coolant passage is smoothened, and the middle region in the axial direction of the stator is able to be efficiently cooled by the coolant. Further, the heat release fin is arranged in the outer region in the axial direction of the coolant passage, and therefore, in the outer region in the axial direction in which it is difficult for the coolant to flow, it is possible to efficiently perform a heat exchange of the heat of the stator with the coolant by the heat release fin. Therefore, according to the rotary electric machine cooling structure according to another aspect of the present invention, the middle region in the axial direction of the stator is able to be efficiently cooled by the coolant while preventing a decrease in a heat exchange efficiency in the outer region in the axial direction of the stator.

### BRIEF DESCRIPTION OF THE DRAWINGS

FIG. 1 is a longitudinal cross-sectional view of a rotary electric machine according to a first embodiment.

FIG. 2 is a longitudinal cross-sectional view showing part of the rotary electric machine according to the first embodiment.

FIG. 3 is a longitudinal cross-sectional view showing part of a rotary electric machine according to a second embodiment.

FIG. 4 is a longitudinal cross-sectional view showing part of a rotary electric machine according to a third embodiment.

FIG. 5 is a cross-sectional view corresponding to a cross-section along a V-V line of FIG. 2 of a rotary electric machine according to a fourth embodiment.

FIG. 6 is a longitudinal cross-sectional view showing part of a rotary electric machine according to a fifth embodiment.

### DESCRIPTION OF THE EMBODIMENTS

Hereinafter, embodiments of the present invention will be described with reference to the drawings. In the embodiments, common parts are given by the same reference numeral, and redundant description is omitted.

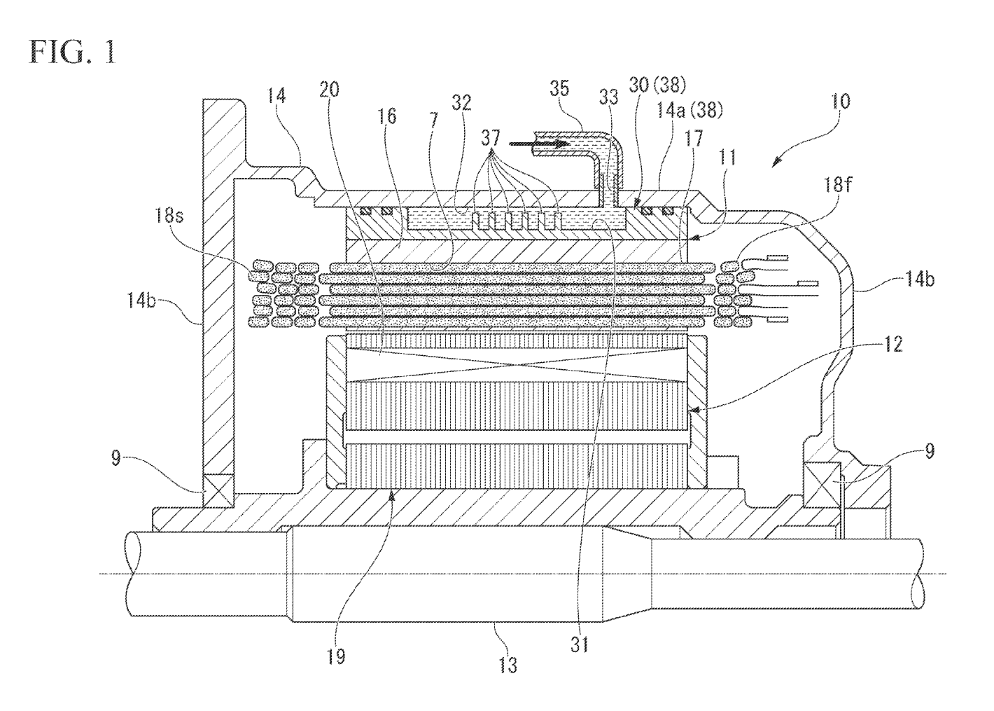

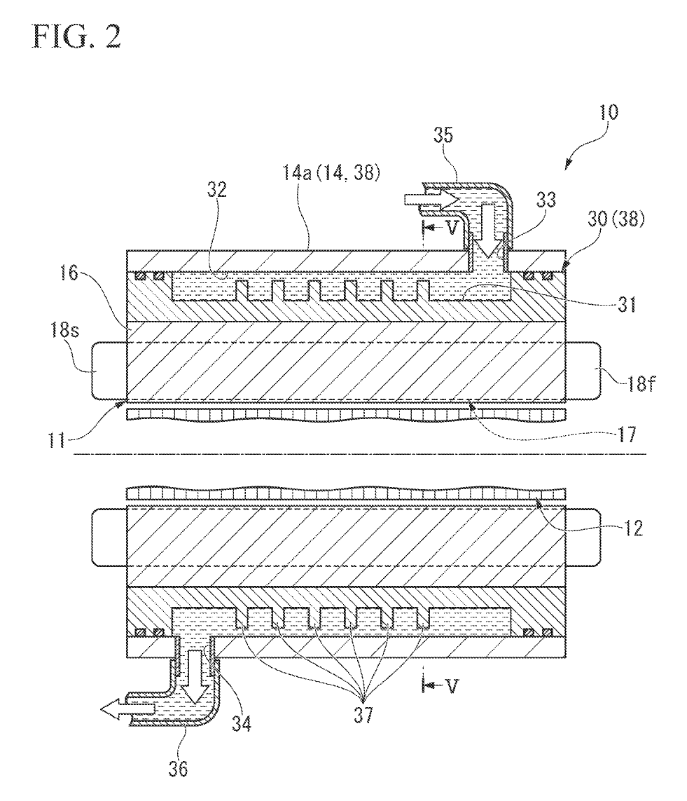

First, a first embodiment shown in FIG. 1 and FIG. 2 is described.

FIG. 1 is a longitudinal cross-sectional view showing a cross-section along an axial direction of a rotary electric machine 10 according to the first embodiment. FIG. 2 is an enlarged longitudinal cross-sectional view showing part of the rotary electric machine 10.

The rotary electric machine 10 of the first embodiment is used for, for example, a drive source of an electric vehicle. The rotary electric machine 10 includes: a stator 11 that generates a rotating magnetic field; a rotor 12 that receives the rotating magnetic field which is generated at the stator 11 and that is rotated; a rotation shaft 13 that is provided concentrically with the rotor 12; and a housing 14 that supports the stator 11 inside the housing 14 and that covers an outside of the stator 11 and the rotor 12.

The stator 11 includes: a stator core 16 that is formed by laminating a plurality of electromagnetic steel plates and that has a substantially cylindrical shape; and a coil 17 that is wound around an edge part on an inner circumferential side of the stator core 16. The coil 17 is constituted of a three-phase coil of a U-phase, a V-phase, and a W-phase. The coil 17 of the first embodiment is formed of segment coils that are used so as to be mutually connected. The segment coil is constituted of a segment conductor which includes: a pair of insertion parts that are inserted in a slot 7 of the stator core 16; and a folded connection part that connects together the insertion parts. An end part of the pair of insertion parts on the opposite side of the folded connection part is a connection part that is connected to another adjacent segment conductor.

In the coil 17, the connection part of each segment conductor is arranged on one end side in the axial direction of the stator 11, and the folded connection part is arranged on another end side in the axial direction of the stator 11. The connection part and the folded connection part protrude outward (are exposed to the outside) from each end part in the axial direction of the stator 11. The connection part and the folded connection part constitute coil ends 18f, 18s of the coil 17. An external electric power line is connected to one coil end 18f. A current is distributed to the coil 17 via the electric power line.

The rotor 12 includes: a rotor core 19 that is joined integrally to an outer surface of the rotation shaft 13; and a plurality of permanent magnets 20 that are arranged on an outer circumferential edge part of the rotor core 19 so as to be separated from each other in a circumferential direction. A plurality of electromagnetic steel plates are laminated, and the rotor core 19 is formed in a substantially cylindrical shape. The rotation shaft 13 is supported rotatably by the housing 14 via a bearing 9. The rotor 12 receives a rotating magnetic field of the stator 11 and is rotated, and thereby, the rotation shaft 13 is rotated integrally with the rotor 12.

The housing 14 includes: a circumferential wall part 14a that covers an outer circumferential side of the stator core 16; and a pair of side wall parts 14b each of which is connected continuously to each of end parts on both sides in the axial direction of the circumferential wall part 14a and covers the outside in the axial direction of the rotor 12 and each of the coil ends 18f, 18s of the coil 17. A stator holder 30 having a substantially cylindrical shape is attached integrally to the outer circumferential surface of the stator core 16 of the stator 11. The stator holder 30 is fixed by press fitting or the like to an inner circumferential surface of the circumferential wall part 14a of the housing 14. A groove 31 having an annular shape elongated in the axial direction is formed on an outer circumferential surface of the stator holder 30. The groove 31 of the stator holder 30 constitutes a coolant passage 32 together with the circumferential wall part 14a in a state where the stator holder 30 is attached to the circumferential wall part 14a of the housing 14. The coolant passage 32 is formed in a cylindrical shape substantially along the outer circumferential surface of the stator 11.

An inflow port 33 that allows a coolant to flow into the coolant passage 32 is formed on one end side in the axial direction of the circumferential wall part 14a of the housing 14. An outflow port 34 (refer to FIG. 2) that allows the coolant to flow out to the outside from the inside of the coolant passage 32 is formed on another end side in the axial direction of the circumferential wall part 14a of the housing 14. The inflow port 33 is provided at a vertically higher position of the circumferential wall part 14a. The outflow port 34 is provided at a vertically lower position of the circumferential wall part 14a.

An introduction pipe 35 for introducing the coolant to the coolant passage 32 from a pump (not shown) is connected to the inflow port 33. A return pipe 36 for allowing the coolant to return to the pump from the coolant passage 32 is connected to the outflow port 34. The introduction pipe 35 is arranged on the outside of the circumferential wall part 14a of the housing 14 substantially along the axial direction of the circumferential wall part 14a, and a front end part of the introduction pipe 35 is bent to a shaft center direction of the circumferential wall part 14a and is connected to the inflow port 33. The return pipe 36 is arranged on the outside of the circumferential wall part 14a of the housing 14 substantially along the axial direction of the circumferential wall part 14a, and a front end part of the return pipe 36 is bent to the shaft center direction of the circumferential wall part 14a and is connected to the outflow port 34.

A plurality of heat release fins 37 for releasing heat that is generated at the stator 11 (mainly at the coil 17) to the coolant inside the coolant passage 32 are provided inside the groove 31 (an inner circumferential surface in the radial direction on the inside of the coolant passage 32) on the outer circumference of the stator holder 30 so as to protrude. The heat release fin 37 is formed in a circular plate shape (annular flange shape) having a constant thickness along the outer circumferential surface of the stator 11.

In the first embodiment, the stator holder 30 and the circumferential wall part 14a of the housing 14 that form the coolant passage 32 constitute a main part of a cooling structure 38.

In the cooling structure 38 of the first embodiment, the plurality of heat release fins 37 are arranged only in a middle region in the axial direction of the coolant passage 32 that is separated from the inflow port 33 and the outflow port 34. All of the plurality of heat release fins 37 are formed to have the same protrusion height and arranged such that all of the pitches between the heat release fins 37 that are adjacent in the axial direction become the same pitch. The coolant that flows into the coolant passage 32 via the inflow port 33 from the introduction pipe 35 proceeds to the middle region in the axial direction from one end side in the axial direction inside the coolant passage 32, passes through a gap between the plurality of heat release fins 37 and an inner wall of the coolant passage 32, and flows out to the return pipe 36 via the outflow port 34 on another end side in the axial direction. In the middle region in the axial direction inside the coolant passage 32, the flow path is narrowed by the plurality of heat release fins 37. Therefore, the coolant that flows through the middle region in the axial direction inside the coolant passage 32 passes through a space by the heat release fin 37 at an increased flow rate.

Although not shown in detail in the drawings, a coolant supply mechanism for supplying the coolant to the coil ends 18f, 18s of the coil 17 is separately provided on an outer part in the axial direction of the stator 11 inside the housing 14.

As described above, in the cooling structure 38 of the rotary electric machine 10 of the first embodiment, the plurality of heat release fins 37 are arranged in the middle region in the axial direction of the coolant passage 32 that is separated from the inflow port 33 and the outflow port 34, and the heat release fin 37 is not arranged in the vicinity of the inflow port 33 and the outflow port 34 inside the coolant passage 32. Therefore, the pressure loss of the coolant becomes small in the vicinity of the inflow port 33 and the outflow port 34 inside the coolant passage 32 where the heat release fin 37 is not provided to protrude, and the coolant smoothly flows. That is, the coolant easily flows into the coolant passage 32 and easily flows out from the coolant passage 32. Further, in the middle region in the axial direction of the coolant passage 32 where the flow path is narrowed by the plurality of heat release fins 37, the flow rate of the coolant that passes is increased, and therefore, it is possible to efficiently perform a heat exchange between the stator 11 and the coolant via the plurality of heat release fins 37.

Accordingly, when the cooling structure 38 of the first embodiment is employed, the flow of the coolant is smoothened in the vicinity of the inflow port 33 and the outflow port 34 inside the coolant passage 32, the flow rate of the coolant is increased in the middle region in the axial direction inside the coolant passage 32, and it is possible to efficiently cool the middle region in the axial direction of the stator 11 by the coolant.

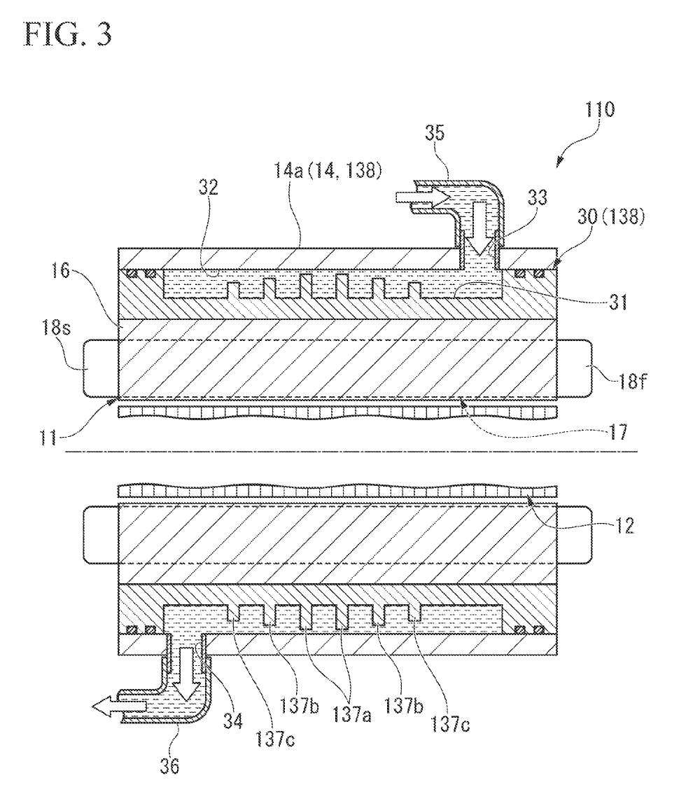

FIG. 3 is a longitudinal cross-sectional view which shows enlarged part of a rotary electric machine 110 according to a second embodiment and which is similar to FIG. 2 of the first embodiment.

In a cooling structure 138 of the rotary electric machine 110 according to the second embodiment, only the configuration of heat release fins 137a, 137b, 137c that are provided inside the groove 31 on the outside of the stator holder 30 so as to protrude is different from that of the first embodiment. In the cooling structure 138 of the second embodiment, all of the heat release fins 137a, 137b, 137c do not have the same protrusion height and are formed such that a heat release fin that is arranged at a further middle position in the axial direction of the coolant passage 32 has a higher protrusion height. In an example shown in FIG. 3, the protrusion heights of two heat release fins 137a that are arranged at the middle in the axial direction of the coolant passage 32 are set to be the highest, and the protrusion heights of heat release fins 137b, 137c that are arranged at the further outside in the axial direction than the heat release fins 137a are set to sequentially become low.

In the cooling structure 138 of the second embodiment, the protrusion heights of the heat release fins 137a, 137b, 137c are set such that the protrusion height of a heat release fin that is arranged at a further middle position in the axial direction of the coolant passage 32 is higher, and therefore, the flow path area inside the coolant passage 32 is smaller at the further middle position in the axial direction. Therefore, the flow rate of the coolant that flows into the coolant passage 32 from the inflow port 33 becomes faster at the further middle position in the axial direction. Accordingly, when the cooling structure 138 of the second embodiment is employed, the middle part in the axial direction of the stator 11 at which heat is easily accumulated is able to be efficiently cooled by the coolant.

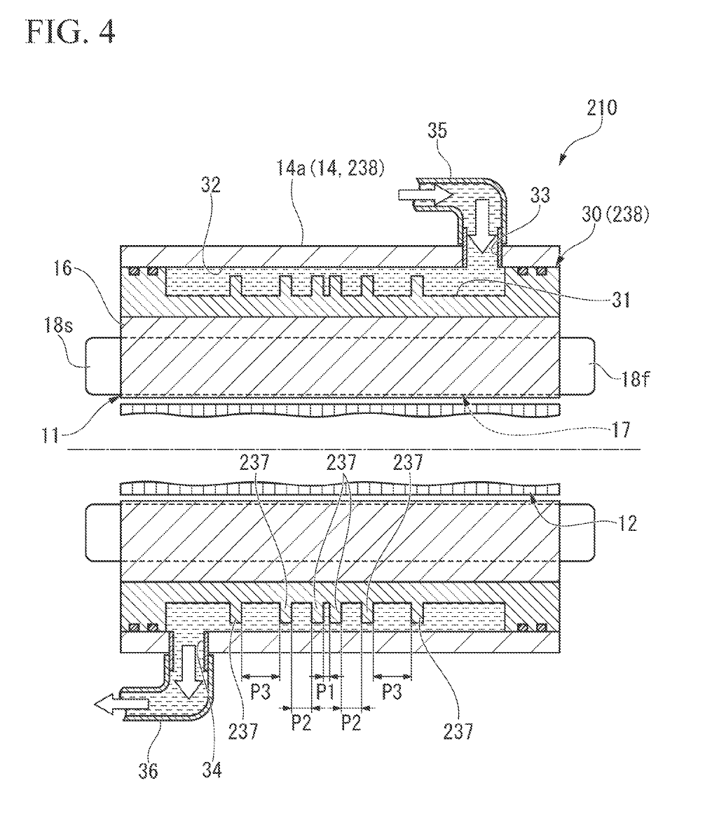

FIG. 4 is a longitudinal cross-sectional view which shows enlarged part of a rotary electric machine 210 according to a third embodiment and which is similar to FIG. 2 of the first embodiment.

In a cooling structure 238 of the rotary electric machine 210 according to the third embodiment, only the arrangement pitch of heat release fins 237 that are provided inside the groove 31 on the outside of the stator holder 30 so as to protrude is different from that of the first embodiment. In the cooling structure 238 of the third embodiment, all of the pitches between heat release fins 237 that are adjacent in the axial direction are not the same, and the pitch between heat release fins that are arranged at a further middle position in the axial direction is narrower. In an example shown in FIG. 4, a pitch p1 between two heat release fins 237 that are arranged at a middle position in the axial direction of the coolant passage 32 is set to be the narrowest, and pitches p2, p3 between heat release fins 237 that are arranged at the further outside in the axial direction than the two heat release fins 237 that are arranged at the middle position are set to be gradually enlarged.

In the cooling structure 238 of the third embodiment, the pitch between the adjacent heat release fins 237 is set to be narrower at a further middle position in the axial direction, and therefore, the flow path area inside the coolant passage 32 is smaller at the further middle position in the axial direction. Therefore, the flow rate of the coolant that flows into the coolant passage 32 from the inflow port 33 becomes faster at the further middle position in the axial direction. Accordingly, also in the case of the cooling structure 238 of the third embodiment, the middle part in the axial direction of the stator 11 at which heat is easily accumulated is able to be efficiently cooled by the coolant.

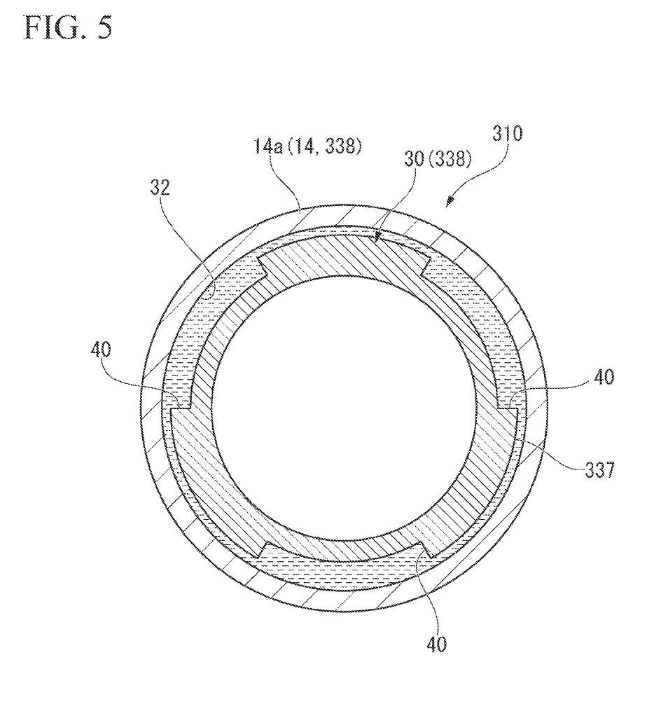

FIG. 5 is a cross-sectional view corresponding to a cross-section along a V-V line of FIG. 2 of the first embodiment and showing a rotary electric machine 310 according to a fourth embodiment.

In a cooling structure 338 of the rotary electric machine 310 of the fourth embodiment, a cutout part 40 (notch part) is provided on a heat release fin 337 that is arranged at an outer end (an outer end in the axial direction on a side close to the inflow port) in the axial direction among a plurality of heat release fins 337 that are arranged in the middle region in the axial direction of the coolant passage 32. In an example shown in FIG. 5, a cutout part 40 having a substantially sector shape is provided at three positions in the circumferential direction of the heat release fin 337.

In the cooling structure 338 of the fourth embodiment, the cutout part 40 is provided on the heat release fin 337 that is arranged at the outer end position in the axial direction, and therefore, the flow path area at the outer end in the axial direction is relatively larger than the flow path area at the middle in the axial direction. Therefore, it is possible to allow the flow rate of the coolant at the middle in the axial direction to be fast and allow the flow rate at the outer end in the axial direction in the arrangement region of the heat release fin 337 to be slow. Particularly, in the fourth embodiment, the cutout part 40 is provided on the heat release fin 337 at the outer end in the axial direction close to the inflow port, and therefore, it is possible to allow the pressure loss of the coolant at the heat release fin 337 part on the outer end in the axial direction to be small and further smoothen the inflow of the coolant.

In the fourth embodiment, the cutout part 40 is provided only on the heat release fin 337 at the outer end in the axial direction; however, it is also possible to provide a cutout part also on a heat release fin other than the heat release fin at the outer end in the axial direction. In this case, a setting can be desirably made such that a heat release fin that is arranged at a further outer position in the axial direction has a larger cutout area in the circumferential direction. Thereby, the flow path area inside the coolant passage is smaller at the further center position (is larger at the further outer position), and it is possible to obtain effects similar to the second embodiment and the third embodiment.

Further, all of the configuration of the second embodiment in which the protrusion heights of the heat release fins are differentiated, the configuration of the third embodiment in which the pitches between the adjacent heat release fins are differentiated, and the configuration of the fourth embodiment in which the cutout areas of the heat release fins are differentiated can be employed for a single cooling structure. Further, it is also possible to appropriately combine arbitrary two of the above configurations.

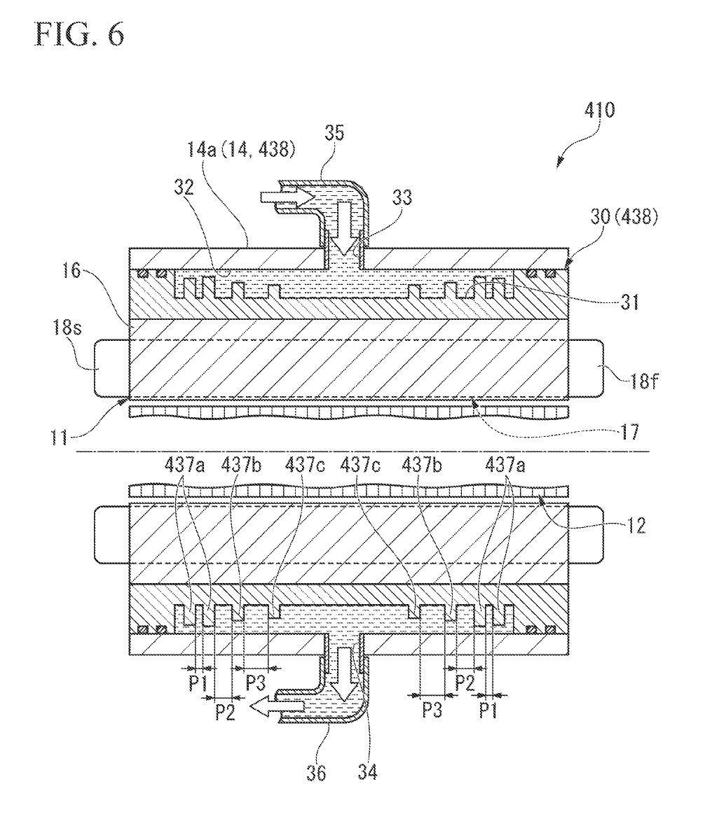

Next, a fifth embodiment shown in FIG. 6 is described.

FIG. 6 is a longitudinal cross-sectional view which shows enlarged part of a rotary electric machine 410 according to the fifth embodiment and which is similar to FIG. 2 of the first embodiment.

In a cooling structure 438 of the rotary electric machine 410 according to the fifth embodiment, the arrangement of the inflow port 33 and the outflow port 34 that are provided on the coolant passage 32, the arrangement of heat release fins 437a, 437b, 437c that are provided inside the groove 31 on the outside of the stator holder 30 so as to protrude, the protrusion heights of the heat release fins 437a, 437b, 437c, and the arrangement pitches p1, p2, p3 of the heat release fins 437a, 437b, 437c are different from those of the first embodiment. In the cooling structure 438 of the fifth embodiment, the inflow port 33 is provided at a vertically higher position of a substantially middle in the axial direction of the coolant passage 32, and the outflow port 34 is provided at a vertically lower position (a position that is separated in the circumferential direction from the inflow port 33) of the substantially middle in the axial direction of the coolant passage 32.

The heat release fins 437a, 437b, 437c are arranged only in one end side region and another end side region (outer region in the axial direction) in the axial direction inside the coolant passage 32 that are separated from the inflow port 33 and the outflow port 34. The heat release fins 437a, 437b, 437c are not arranged at parts close to the inflow port 33 and the outflow port 34 inside the coolant passage 32.

The heat release fins 437a, 437b, 437c that are arranged in one end side region and another end side region inside the coolant passage 32 consist of two heat release fins 437a having the highest protrusion height, one heat release fin 437b having a lower protrusion height than the heat release fins 437a, and one heat release fin 437c having a further lower protrusion height than the heat release fin 437b. The heat release fins 437a, 437b, 437c are formed such that one that is arranged at a further outer position in the axial direction of the coolant passage 32 has a higher protrusion height. Therefore, a heat release fin that is arranged at a further outer position in the axial direction of the coolant passage 32 among the heat release fins 437a, 437b, 437c has a larger contact area with the coolant.

All of the pitches between the heat release fins 437a, 437b, 437c that are adjacent in the axial direction are not the same, and the pitch between heat release fins that are arranged at a further outer (end part side) position in the axial direction is narrower. In an example shown in FIG. 6, a pitch p1 between the two heat release fins 437a, 437a that are arranged at an the most outside position in the axial direction of the coolant passage 32 is set to be the narrowest, and a pitch p2 between the heat release fins 437a, 437b at a further inside in the axial direction than the two heat release fins 437a, 437a and a pitch p3 between the heat release fins 437b, 437c are set to be gradually enlarged.

In the cooling structure 438 of the fifth embodiment, when the coolant flows into the coolant passage 32 via the inflow port 33 from the introduction pipe 35, part of the coolant flows downward along the circumferential direction in the middle region in the axial direction and flows out to the return pipe 36 via the outflow port 34 at a vertically lower position. At this time, since the heat release fins 437a, 437b, 437c are not provided in the middle region in the axial direction of the coolant passage 32 so as to protrude, a flow path resistance in the vicinity of the inflow port 33 and in the vicinity of the outflow port 34 becomes small, and the coolant smoothly flows from the inflow port 33 toward the outflow port 34. Accordingly, the middle region in the axial direction of the stator 11 is efficiently cooled by the coolant.

Further, part of the coolant that flows into the coolant passage 32 from the inflow port 33 also flows in the outer region in the axial direction inside the coolant passage 32. At this time, the flow volume of the coolant that is directed from the inflow port 33 toward the outflow port 34 is large, and therefore, the flow volume of the coolant that flows in the outer region in the axial direction inside the coolant passage 32 becomes relatively small. However, the plurality of heat release fins 437a, 437b, 437c are provided in the outer region in the axial direction inside the coolant passage 32 so as to protrude, and therefore, a heat exchange is efficiently performed between the coolant and the outer region in the axial direction of the stator 11 via the plurality of heat release fins 437a, 437b, 437c.

As described above, in the cooling structure 438 of the rotary electric machine 410 according to the fifth embodiment, the inflow port 33 and the outflow port 34 are provided in the middle region in the axial direction of the coolant passage 32 so as to be separated in the circumferential direction, and the plurality of heat release fins 437a, 437b, 437c are arranged in one end side region and another end side region in the axial direction that are separated from the inflow port 33 and the outflow port 34. Therefore, in the middle region in the axial direction of the coolant passage 32, the coolant is allowed to flow smoothly from the inflow port 33 to the outflow port 34, and it is possible to efficiently cool the middle region in the axial direction of the stator 11 by the coolant. Further, in the cooling structure 438 of the fifth embodiment, the heat release fins 437a, 437b, 437c are arranged in the outer region in the axial direction of the coolant passage 32, and therefore, in the outer region in the axial direction in which it is difficult for the coolant to flow, it is possible to efficiently perform a heat exchange of the heat of the stator 11 with the coolant by the heat release fins 437a, 437b, 437c.

Accordingly, when the cooling structure 438 of the fifth embodiment is employed, it is possible to efficiently cool the middle region in the axial direction of the stator 11 by the coolant while preventing a decrease in a heat exchange efficiency in the outer region in the axial direction of the stator 11.

Further, in the cooling structure 438 of the fifth embodiment, the heat release fins 437a, 437b, 437c are formed such that one that is arranged at a further outer position in the axial direction of the coolant passage 32 has a higher protrusion height, and thereby, the heat release fin that is arranged at the further outer position in the axial direction has a larger contact area with the coolant. Therefore, it is possible to enhance a heat exchange efficiency with the coolant for a heat release fin among the heat release fins 437a, 437b, 437c that is arranged at a position closer to the end part in the axial direction of the coolant passage 32. Accordingly, when the configuration of the fifth embodiment is employed, even at an outer part in the axial direction where the flow of the coolant inside the coolant passage 32 becomes small, it is possible to efficiently perform a heat exchange of the heat of the stator 11 with the coolant.

Further, in the cooling structure 438 of the fifth embodiment, one heat release fin 437 among the heat release fins 437a, 437b, 437c that is arranged at a further outer position in the axial direction of the coolant passage 32 has a narrower pitch between the one heat release fin 437 and an adjacent heat release fin 437 among the heat release fins 437a, 437b, 437c. Therefore, the density of the heat release fins 437a, 437b, 437c per an axial direction distance is higher at a further outer region in the axial direction of the coolant passage 32, and a heat exchange efficiency with the coolant by the heat release fins 437a, 437b, 437c is enhanced. Accordingly, when the configuration of the fifth embodiment is employed, it is possible to enhance a heat exchange efficiency of the stator 11 at the outer part in the axial direction of the coolant passage 32.

The present invention is not limited to the embodiments described above, and a variety of design changes can be made without departing from the scope of the invention. For example, even in the cooling structure 438 of the fifth embodiment, a cutout part may be appropriately provided on the heat release fins 437a, 437b, 437c. In this case, the cutout area of the cutout part of a heat release fin that is arranged at a further inner position in the axial direction can be desirably enlarged.

What is claimed is:

1. A rotary electric machine cooling structure which comprises a coolant passage that is provided on an outer circumferential part of a stator and that has a cylindrical shape substantially along an outer circumferential surface of the stator, the rotary electric machine cooling structure comprising:
a coolant inflow port that is provided on one end side in an axial direction of the coolant passage;
a coolant outflow port that is provided on another end side in the axial direction of the coolant passage; and
a plurality of heat release fins that protrude outward in a radial direction from an inner circumferential surface in a radial direction inside the coolant passage,
wherein the heat release fin is arranged in a middle region in the axial direction of the coolant passage that is separated from the inflow port and the outflow port.

2. The rotary electric machine cooling structure according to claim 1,
wherein the plurality of heat release fins are formed such that one of the plurality of heat release fins that is arranged at a further middle position in the axial direction of the coolant passage has a higher protrusion height.

3. The rotary electric machine cooling structure according to claim 1,
wherein one heat release fin among the plurality of heat release fins that is arranged at a further middle position in the axial direction of the coolant passage has a narrower pitch between the one heat release fin and an adjacent heat release fin among the plurality of heat release fins.

4. The rotary electric machine cooling structure according to claim 1,
wherein one of the plurality of heat release fins that is arranged at a further outer position in the axial direction of the coolant passage is set such that a cutout area in a circumferential direction is larger.

5. A rotary electric machine cooling structure which comprises a coolant passage that is provided on an outer circumferential part of a stator and that has a cylindrical shape substantially along an outer circumferential surface of the stator, the rotary electric machine cooling structure comprising:
a coolant inflow port that is provided in a middle region in an axial direction of the coolant passage;
a coolant outflow port that is provided in a middle region in the axial direction of the coolant passage and at a position which is separated in a circumferential direction from the inflow port; and
a plurality of heat release fins that protrude outward in a radial direction from an inner circumferential surface in a radial direction inside the coolant passage,
wherein the heat release fin is arranged in an outer region in the axial direction of the coolant passage that is separated from the inflow port and the outflow port.

6. The rotary electric machine cooling structure according to claim 5,
wherein the plurality of heat release fins are formed such that one of the plurality of heat release fins that is arranged at a further outer position in the axial direction of the coolant passage has a higher protrusion height.

7. The rotary electric machine cooling structure according to claim 5,
wherein one heat release fin among the plurality of heat release fins that is arranged at a further outer position in the axial direction of the coolant passage has a narrower pitch between the one heat release fin and an adjacent heat release fin among the plurality of heat release fins.
